(19) United States
(12) Patent Application Publication
(10) Pub. No.: US 2012/0219152 A1
(43) Pub. Date: Aug. 30, 2012

(54) KEY INFORMATION MANAGEMENT SYSTEM, RECORD REPRODUCTION APPARATUS, AND KEY INFORMATION MANAGEMENT APPARATUS

(75) Inventors: Suguru Yorifuji, Kanagawa (JP); Kazumasa Miyazaki, Tokyo (JP); Takafumi Masuda, Kanagawa (JP); Norihiko Sato, Tokyo (JP); Toshihiko Suzuki, Tokyo (JP)

(73) Assignee: SONY CORPORATION, Tokyo (JP)

(21) Appl. No.: 13/358,005

(22) Filed: Jan. 25, 2012

(30) Foreign Application Priority Data
Feb. 1, 2011 (JP) P2011-019840

(51) Int. Cl. G06F 21/00

(52) U.S. Cl. 380/277

(57) ABSTRACT

A key information management system includes one or more record reproduction apparatuses and a key information management server. Each record reproduction apparatus has a substrate which can be replaced, and a nonvolatile storage unit which is mounted on the substrate and stores substrate identification information and key information of an encryption key. The key information management server includes a storage unit for storing the substrate identification information and the key information of the substrate in association with product identification information of the record reproduction apparatus, and the key information management server permits access to the storage unit through authentication. The record reproduction apparatus accesses the key information management server through the authentication after the substrate is replaced, and then rewrites substrate identification information and key information of the substrate after the replacement using the substrate identification information and key information of the substrate before replacement.

### BACKGROUND

The present disclosure relates to a key information management system, a record reproduction apparatus, and a key information management apparatus which manage unique key information allocated to each record reproduction apparatus, and, in particular, to a key information management system, a record reproduction apparatus, and a key information management apparatus which manage the key information of each record reproduction apparatus such that a record reproduction apparatus whose substrate is replaced can continuously reproduce content which was recorded before the substrate is replaced.

In digital broadcasting, “server-type broadcasting” or “storage-type broadcasting” in which program content, delivered through broadcasting or delivery lines, is stored together with associated content metadata in the record reproduction apparatus of a reception terminal (home server) has been widely known. According to the server-type broadcasting, high-degree watching service, such as digest watching, multi-scenario watching, program request watching, and automatic program recording, can be provided. In Japan, encoding, transmission and storage control methods for the server-type broadcasting have been standardized in Association of Radio Industries and Businesses (ARIB) STD-B38, and the technical data of the server-type broadcasting has been regulated in ARIB TR-B27.

Meanwhile, since illegal operations, such as copying or falsification, may be comparatively easily performed on digitized content, it is necessary to provide protection against illegal use from a technical side in addition to the protection based on the relevant law such as copyright law. For example, ARIB TR-B14 6.2.3 regulates that “a storing operation may be performed on a recording medium only when encryption using a local password described in Part 1, 6.2.4 of this volume or a protection mechanism which may prevent illegal extraction or copying by a user from being performed is devised with respect to the protection target described in Part 1, 6.1.2 of this volume in conformity with the functional conditions of a receiver described in Part 1, Chapter 5 of this volume”. ARIB TR-B14 6.2.4.2 regulates that “a secure key management means, such as the use of a unique receiver key or a key generated using unique receiver information, should be used such that management is performed in order to ensure the reproduction of content is disabled when a recording media is connected to other receiver units or other equipment, or when content is illegally copied onto the recording media of other equipment.” That is, in ARIB, when digital broadcasting content is recorded in an information recording medium, such as Hard Disk Drive (HDD), it is preferable that the recorded content be reproduced using only the record reproduction apparatus which performed the recording in such a way that the content is recorded after encryption is performed thereon using a predetermined encryption key and the encryption key is unique for each apparatus.

For example, when the copyrighted data of content is recorded in a general-purpose HDD, an information record reproduction apparatus capable of preventing illegal copying of content has been proposed (for example, refer to Japanese Unexamined Patent Application Publication No. 2005-276282).

Further, a manufacturer which manufactures an apparatus has proposed a record reproduction apparatus for simply and securely managing an encryption key for each apparatus in order to protect content (for example, refer to Japanese Unexamined Patent Application Publication No. 2010-191816). The record reproduction apparatus generates a content encryption key in the record reproduction apparatus using first unique information based on an installer read from a USB memory, and generates a private key used to wrap the content encryption key in the record reproduction apparatus using second unique information. Thereafter, a wrap content encryption key which wrapped the content encryption key using the private key is stored in a flash ROM.

In order to enable only the record reproduction apparatus which recorded content as described above to reproduce the recorded content, the unique key information of the corresponding apparatus is generally managed in the nonvolatile memory of the record reproduction apparatus. However, when a nonvolatile memory is replaced or recorded content is deleted, for example, when the substrate of the record reproduction apparatus is replaced for the purpose of repair when failure occurs, key information is lost. In this case, since it is difficult to decrypt the content, which was recorded before the repair is performed, on the same record reproduction apparatus, it is difficult to reproduce the recorded content.

Even after the repair, such as the replacement of a substrate, is performed on the record reproduction apparatus, the use of recorded content is still in an individual or domestic range which is permitted by copyright law. Nevertheless, if it becomes difficult to reproduce content which could be previously reproduced following repairs, a user is inconvenienced. Even though the information recording medium itself, such as an HDD, which recorded the content is normal, the user may make the mistake that the information recording medium is out of order. Further, the user entertains the wrong impression, for example, that the performance or quality of a product is not good or the apparatus is in bad repair.

### SUMMARY

There is a need for an excellent key information management system, a record reproduction apparatus, and a key information management apparatus which are capable of appropriately managing unique key information allocated to each record reproduction apparatus.

Further, there is another need for an excellent key information management system, a record reproduction apparatus, and a key information management apparatus which are capable of managing the key information of each record reproduction apparatus such that a record reproduction apparatus whose substrate is replaced can continuously reproduce content which was recorded before the substrate is replaced.

A key information management system according to an embodiment of the present disclosure includes one or more record reproduction apparatuses each of which includes a substrate on which main components are mounted and which is replaceable from a main body of an apparatus, and a nonvolatile storage unit which is mounted on the substrate and which at least stores substrate identification information, used to identify the substrate, and key information of an encryption key; and a key information management server which includes a storage unit for storing the substrate identification information and key information of the substrate, attached to each record reproduction apparatus, in association with product identification information of the record reproduction apparatus, and which permits an access to the storage unit through authentication. The record reproduction apparatus accesses the key information management server through the authentication after the substrate is replaced, and then rewrites substrate identification information and key information of the substrate after the replacement, which are stored in the nonvolatile storage unit, with the substrate identification information and key information of the substrate before the replacement.

However, the “system” described herein indicates that a plurality of apparatuses (or functional modules for implementing specific functions) are logically aggregated, and it does not matter whether each apparatus or functional module exists in a single package.

Further, a record reproduction apparatus according to another embodiment of the present disclosure, includes a substrate on which main components are mounted and which is replaceable from a main body of an apparatus; a nonvolatile storage unit which is mounted on the substrate, and at least store substrate identification information, used to identify the substrate, and key information of an encryption key;

a connection unit which connects one or more external information recording mediums to the substrate; a record reproduction unit which records content in the external information recording medium which is connected to the connection unit or which reproduces content from the external information recording medium; an encryption unit configured to encrypt or decrypt content using the encryption key generated based on the key information stored in the nonvolatile storage unit when the record reproduction unit records or reproduces the content; and a processing unit which, when the substrate of the main body of the apparatus is replaced, rewrites substrate identification information and key information after replacement, which are stored in the nonvolatile storage unit of the replaced substrate, with the substrate identification information and the key information which were stored in the nonvolatile storage unit of the substrate before replacement, and which takes over the external information recording medium connected to the connection unit of the substrate before replacement using the substrate after replacement.

The record reproduction apparatus according to the embodiment of the present disclosure may further include a communication unit which connects to a network. The processing unit may access a key information management server for storing the substrate identification information and the key information of the substrate attached to the record reproduction apparatus in association with product identification information of the record reproduction apparatus, obtains the substrate identification information and the key information of the substrate before replacement, and then rewrite the substrate identification information and the key information which are stored in the nonvolatile storage unit of the substrate after replacement.

The record reproduction apparatus according to the embodiment of the present disclosure may further include a registration unit which allocates a registration number to the external information recording medium connected to the connection unit, and registers the external information recording medium by writing an object identification region, in which the registration number is written, into the nonvolatile storage unit and writing an identification data region, in which the substrate identification information and the registration number are written, into the external information recording medium.

The record reproduction apparatus according to the embodiment of the present disclosure may further include a recognition unit which reads the substrate identification information and the registration number, which were written in the identification data region, from the external information recording medium connected to the connection unit, and, when the read substrate identification information is matched with the substrate identification information stored in the nonvolatile storage unit and when the object identification region which matches with the read registration number does not exist in the nonvolatile storage unit, recognizes the external information recording medium as the external information recording medium registered by the registration unit.

The record reproduction apparatus according to the embodiment of the present disclosure, the record reproduction unit may record content in the external information recording medium which was registered by the registration unit or which was recognized as being registered by the recognition unit.

The record reproduction apparatus according to the embodiment of the present disclosure, the takeover processing unit may reconfigure the object identification region by writing the object identification region, in which the registration number of the external information recording medium recognized by the recognition unit from among the external information recording mediums connected to the connection unit of the substrate after replacement is written, into the nonvolatile storage unit.

Further, a key information management apparatus according to further another embodiment of the present disclosure includes a storage unit which stores substrate identification information and key information of a substrate attached to each record reproduction apparatus in association with product identification information of each of the record reproduction apparatuses; and an access control unit which accesses the storage unit through a predetermined authentication process.

The key information management apparatus according to the embodiment of the present disclosure, the access control unit may permit access to a data writing operation which is performed when each record reproduction apparatus is manufactured.

The key information management apparatus according to the embodiment of the present disclosure may further include an identification information generation unit which generates the substrate identification information and key information of the substrate attached to each of the record reproduction apparatuses.

According to the embodiments of the present disclosure, there are provided an excellent key information management system, a record reproduction apparatus, and a key information management apparatus which are capable of managing the key information of each record reproduction apparatus such that a record reproduction apparatus whose substrate is replaced can continuously reproduce content which was recorded before the substrate was replaced.

Other, features, and advantages according to the embodiments of the present disclosure will be apparent based on the further detailed description based on the embodiments and accompanying drawing of the present disclosure which will be described below.

### BRIEF DESCRIPTION OF THE DRAWINGS

FIG. 1 is a view schematically illustrating the configuration of an information management system according to an embodiment of the present disclosure;

FIG. 2 is a view illustrating an example of the configuration of a record reproduction apparatus;

FIG. 3 is a view illustrating an example of the configuration of a key information management server;

FIG. 4 is a view illustrating data and data structure to be described in the flash ROM of the record reproduction apparatus;

FIG. 5 is a view illustrating data and data structure to be described in an external information recording medium which is connected to the record reproduction apparatus;

FIG. 6 is a view illustrating data and data structure to be described in the storage unit of a key information management server;

FIG. 7 is a view illustrating a process of configuring the data structure in the storage unit of the key information management server (refer to FIG. 6) when the record reproduction apparatus is manufactured;

FIG. 8 is a view illustrating a process of configuring the data structure in the flash ROM (refer to FIG. 4) by connecting the external information recording medium to the record reproduction apparatus;

FIG. 9A is a flowchart illustrating a process procedure of taking over the external information recording medium;

FIG. 9B is a flowchart illustrating a process procedure of taking over the external information recording medium;

FIG. 10A is a view illustrating the state of the flash ROM of a substrate A before replacement;

FIG. 10B is a view illustrating the state of the flash ROM of a substrate B after replacement;

FIG. 10C is a view illustrating the state of the flash ROM at the time that substrate identification information SetId and key information SEED are rewritten in the substrate B after replacement; and

FIG. 10D is a view illustrating the state of the flash ROM when this process routine is terminated.

### DETAILED DESCRIPTION OF EMBODIMENTS

Embodiments of the present disclosure will be described in detail below with reference to the drawings.

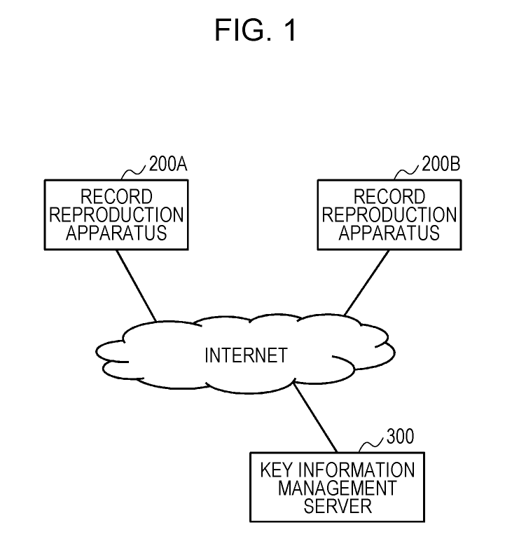

FIG. 1 schematically illustrates the configuration of an information management system according to an embodiment of the present disclosure. The information management system of the drawing includes one or more record reproduction apparatuses 200A, 200B, . . . and a key information management server 300. Each of the record reproduction apparatuses 200A, 200B, . . . and the key information management server 300 may be connected to each other via a wide area network such as the Internet.

A record reproduction apparatus 200 receives digital broadcasting which is permitted to record broadcasting streams, records the digital broadcasting by encrypting the digital broadcasting using the unique private key of an apparatus, and reproduces the digital broadcasting by decrypting recorded content. In the present embodiment, the record reproduction apparatus 200 includes one or more external information recording mediums, such as an HDD which is externally connected through a USB interface, and records the broadcast content on which encryption is performed in the external information recording medium.

The key information management server 300 manages key information (SEED of an encryption key) which is used such that each of the record reproduction apparatuses 200A, 200B, . . . generates the unique private key of an apparatus. In order to access the key information managed by the key information management server via a network or another interface, authentication is necessary.

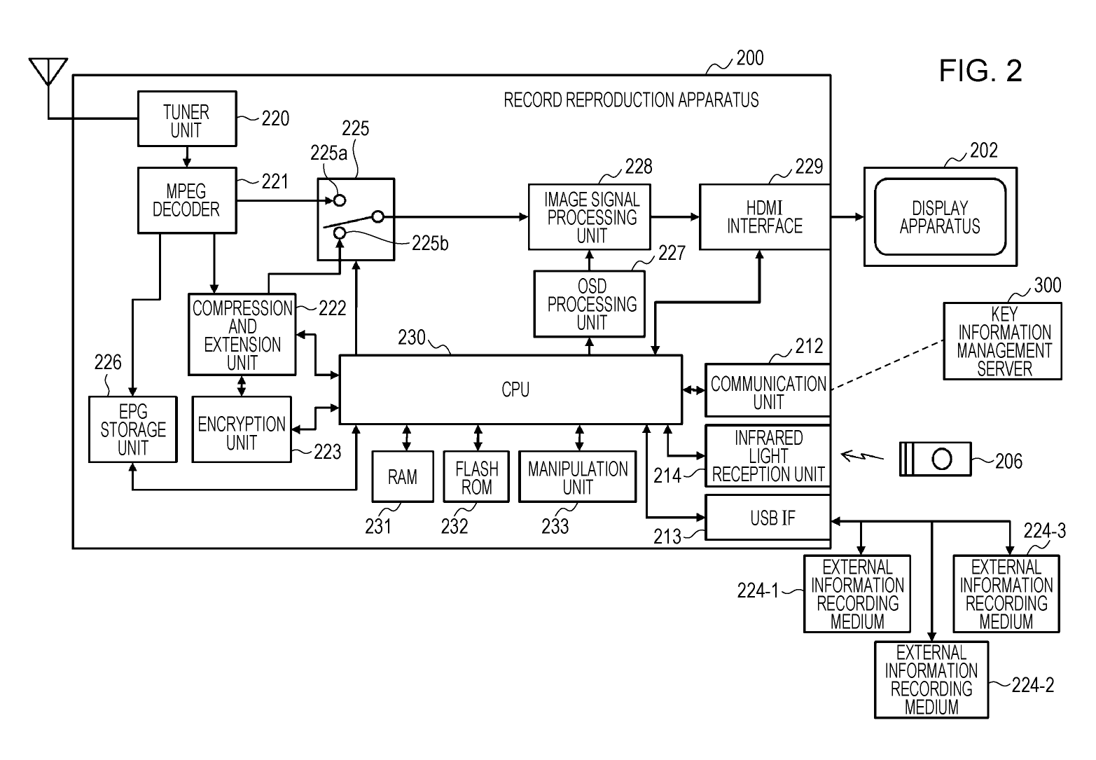

FIG. 2 illustrates an example of the configuration of the record reproduction apparatus 200. The record reproduction apparatus 200 receives a broadcasting signal transmitted from a broadcasting station, and then supplies the image signal and the audio signal of program content to a display apparatus 202 or records the image signal and audio signal of the program content in the external information recording medium such as an HDD. Further, the record reproduction apparatus 200 reads the image signal and the audio signal of the content recorded in the external information recording medium, and then supplies the image signal and the audio signal to the display apparatus 202. Further, the received broadcasting signal includes a program information signal, such as Electronic Program Guide (EPG) in addition to the image signal and the audio signal which correspond to the content. Further, for the purpose of the simplification of description, only the image signal will be described below among the image signal and the audio signal which are obtained from the broadcasting signal. However, a process, which is the same as the process performed on the image signal, is performed on the audio signal.

The record reproduction apparatus 200 connects the display apparatus 202 using, for example, a High Definition Multimedia Interface (HDMI) interface 229. The display apparatus 202 includes a Liquid Crystal Display (LCD) or a Plasma Display Panel (PDP), displays an image corresponding to the image signal supplied from the record reproduction apparatus 200, and outputs audio corresponding to the audio signal.

Further, the record reproduction apparatus 200 includes a communication unit 212, a Universal Serial Bus (USB) interface 213, and an infrared light reception unit 214 for the purpose of input or output from or to the outside.

The communication unit 212 includes a network interface card. The record reproduction apparatus 200 can communicate with a host, such as the key information management server 300, on the network in conformity with a communication protocol, such as the Ethernet (registered trademark), through the communication unit 212.

The USB interface 213 is connected to one or more USB devices including the external information recording mediums 224-1, 224-2, . . . such as a USB memory or an USB HDD. In the present embodiment, the record reproduction apparatus 200 records broadcasting content on which encryption is performed in the externally connected external information recording medium 224 through the USB interface.

The infrared light reception unit 214 receives an infrared signal transmitted from a remote commander (remote controller) 206, converts the infrared signal into a remote controller operation signal, and then supplies the resulting signal to the record reproduction apparatus 200.

The record reproduction apparatus 200 internally includes a tuner unit 220, an MPEG decoder 221, a compression and extension unit 222, an encryption unit 223, switch 225, an EPG storage unit 226, an On Screen Display (OSD) processing unit 227, an image signal processing unit 228, and an HDMI interface 229. Further, the record reproduction apparatus 200 includes a Central Processing Unit (CPU) 230, a Random Access Memory (RAM) 231, and a flash Read-Only Memory (ROM) 232 in order to generally control the entire operations of the apparatus in response to the operations of a user. The entire or most of these main circuit modules including the flash ROM 232 are mounted on a single substrate. When the record reproduction apparatus 200 is out of order or receives maintenance, a part of the circuits of the substrate may be replaced or the whole substrate may be replaced for the purpose of repairs.

The broadcasting signal of terrestrial digital broadcasting which is received by an antenna (not shown) is supplied to the tuner unit 220. The tuner unit 220 receives a broadcasting signal within a frequency band corresponding to a channel indicated by a user under the control of the CPU 230, and then performs detection and demodulation. Thereafter, the tuner unit 220 provides Moving Pictures Exports Group-2 (MPEG2) transport streams, obtained as the results of the detection and the demodulation, to the MPEG decoder 221. Since a program which is different from a program which is being watched by a user may be recorded, the record reproduction apparatus 200 may include two or more tuners. Further, the purpose of each of the two or more tuners may be fixed with, for example, live broadcasting watching or program recording.

A broadcasting signal which can be received by the tuner unit 220 may include the broadcasting signal of digital satellite broadcasting, such as Broadcasting Satellite (BS) or Communication Satellite (CS), cable television broadcasting, and streaming broadcasting supplied via a network such as the Internet, in addition to terrestrial digital broadcasting.

The MPEG decoder 221 performs a descrambling process on the MPEG2 transport stream supplied from the tuner unit 220, and then divides the stream into TS packets, including image data, audio data, and program information data (performs demultiplexing process). Thereafter, the MPEG decoder 221 extracts the image data included in the TS packet, performs MPEG decoding thereon, and then supplies an image signal, obtained as the results of the MPEG decoding, to the compression and extension unit 222 and the switch 225. Further, the MPEG decoder 221 extracts EPG data included in the TS packet, and then supplies the extracted EPG data to the EPG storage unit 226.

The compression and extension unit 222 compresses (encodes) the image signal supplied from the MPEG decoder 221, and then supplies the resulting image signal to the encryption unit 223. Further, the compression and extension unit 222 extends (decodes) the compressed image signal supplied from the encryption unit 223, and then supplies the resulting image signal to the switch 225.

The encryption unit 223 encrypts the image signal supplied from the compression and extension unit 222 using a predetermined encryption key in order to protect content. The external information recording medium, such as an USB HDD, records the image signal, on which the compression process and encryption were performed, under the control of the CPU 230. Further, the external information recording medium 224 reads the encrypted image signal, which is being recorded, and then supplies the encrypted image signal to the encryption unit 223 under the control of the CPU 230. The encryption unit 223 decodes the encrypted image signal supplied from the external information recording medium 224 using the encryption key, and then supplies the decoded image signal to the compression and extension unit 222. The encryption unit 223 uses an Advanced Encryption Standard (AES) encryption method using a 128-bit encryption key as an encryption method. Meanwhile, the encryption key is unique to the corresponding record reproduction apparatus 200 and is supplied from the CPU 230.

The switch 225 switches the image signal to be output to the image signal processing unit 228 by switching on internal terminal units 225a and 225b under the control of the CPU 230. The image signal output from the MPEG decoder 221 is supplied to the terminal unit 225a, and the image signal output from the compression and extension unit 222 is supplied to the terminal unit 225b. When a user watches broadcasting content in real time, the CPU 230 selects the terminal unit 225a, and causes the image signal of a predetermined broadcasting station which was received using the tuner unit 220 to be supplied to the image signal processing unit 228 through the MPEG decoder 221. Meanwhile, when the user watches content recorded in the external information recording medium 224, the CPU 230 selects the terminal unit 225b and causes the image signal read from the external information recording medium 224 to be supplied to the image signal processing unit 228.

The OSD processing unit 227 generates an OSD signal corresponding to an image, such as text or figures, superimposed on the image of the content according to the instruction of the CPU 230, and then supplies the OSD signal to the image signal processing unit 228. For example, the OSD processing unit 227 generates an image, such as an image, which displays the channel number during a channel selection or audio volume, and a recording reservation screen Graphical User Interface (GUI), which is displayed when the recording reservation of a program is performed, as the OSD signal.

The image signal processing unit 228 supplies the image signal supplied through the switch 225 to the display apparatus 202 via the HDMI interface 229. Further, the image signal processing unit 228 converts the OSD signal supplied from the OSD processing unit 227 into an image signal, and then supplies the resulting signal to the display apparatus 202 via the HDMI interface 229. Furthermore, the image signal processing unit 228 generates an image signal obtained in such a way that an image indicated by the OSD signal is superimposed on the image signal supplied via the switch 225, and then supplies the generated image signal to the display apparatus 202 through the HDMI interface 229.

The HDMI interface 229 obtains an image signal format which can be accepted by the display apparatus 202, converts the image signal supplied from the image signal processing unit 228 in conformity with the HDMI standard, that is, converts the image signal into image signal format which can be accepted by the display apparatus 202, and then outputs the resulting signal to the display apparatus 202.

The flash ROM 232 stores a program, which is run by the CPU 230, and information, which is necessary for a process executed in the program, in a nonvolatile manner. The flash ROM 232 stores key information SEED which is used to generate an encryption key, substrate identification information SetId which is used to identify a substrate, and information which is related to the external information recording medium 224 (which will be described later) which is connected to the USB interface 213. The CPU 230 runs a program which was loaded into the RAM 231 from the flash ROM 232, and then performs the process of recording or reproducing content, registering the external information recording medium 224 (which will be described later), and taking over the external information recording medium 224 (which will be described later) after a substrate is replaced.

A manipulation unit 233 is provided on, for example, the front of the main body of the record reproduction apparatus 200. The manipulation unit 233 is provided with various types of manipulation buttons including a power button. When the manipulation buttons are operated by a user, the manipulation unit 233 supplies an operational signal corresponding to the operated manipulation button to the CPU 230.

For example, in order to record the content of a program designated by a user through the manipulation unit 233, the CPU 230 designates a reception station for the tuner unit 220, causes the compression and extension unit 222 and the encryption unit 223 to perform compression and encryption on a received image signal, and then records the image signal in the external information recording medium 224. Further, the CPU 230 controls the reproduction of the content recorded in the external information recording medium 224 based on the operation of the user. That is, the CPU 230 causes the compression and extension unit 222 and the encryption unit 223 to perform decryption and extension on the encryption content read from the external information recording medium 224, and causes the switch 225 to select the terminal unit 225b, thereby outputting the reproduced image signal to the display apparatus 202. Further, when the content is recorded or reproduced, the CPU 230 generates an encryption key based on the key information SEED read from the flash ROM 232 and then supplies the generated encryption key to the encryption unit 223.

As described above, received content, such as terrestrial digital broadcasting, is recorded in the external information recording medium 224. It is necessary that an encryption key used for encryption is unique to the corresponding record reproduction apparatus 200 in conformity with ARIB mounting reference (robustness rule). In the present embodiment, the key information SEED which is used to generate the encryption key is stored in the flash ROM 232. The SEED is unique to the substrate (described above) of the relevant record reproduction apparatus 200, and, for example, is written in the flash ROM 232 before shipment by the manufacturer of the corresponding record reproduction apparatus 200. When the content is encrypted or the encrypted content is decrypted and reproduced, the CPU 230 reads SEED from the flash ROM 232, applies a predetermined arithmetic process on the SEED, generates a unique encryption key of the corresponding record reproduction apparatus 200, and then supplies the generated encryption key to the encryption unit 223.

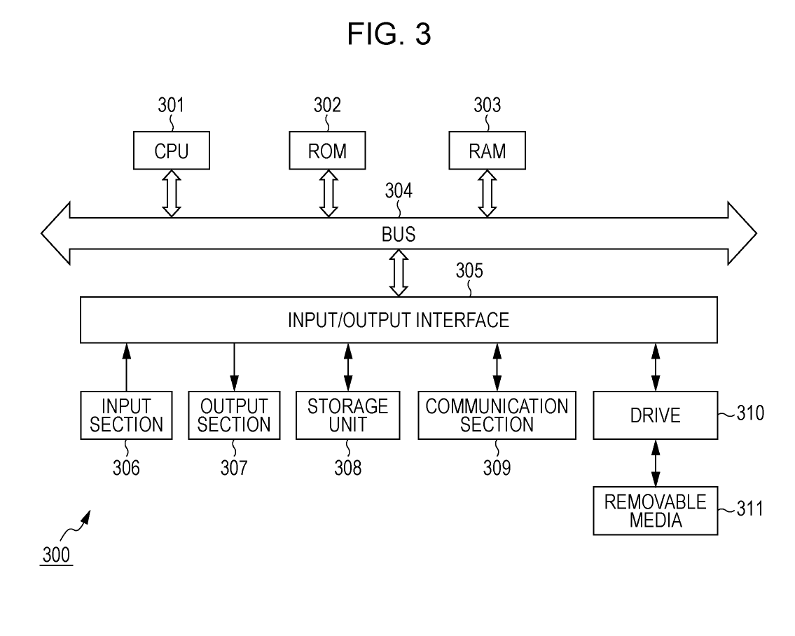

FIG. 3 illustrates an example of the configuration of the key information management server 300. The key information management server 300 can be configured using a general computer.

The CPU 301, a ROM 302, and a RAM 303 are connected with each other using a bus 304. Further, the bus 304 is connected to an input/output interface 305. The input/output interface 305 is connected to an input unit 306, an output unit 307, a storage unit 308, a communication unit 309, and a drive 310.

The input unit 306 includes, for example, a keyboard, a mouse, and a microphone. The output unit 307 includes, for example, a display and a speaker. The storage unit 308 includes a hard disk or a nonvolatile memory, and stores a program file and a data file which are executed by the CPU 301. The communication unit 309 includes a network interface card. The key information management server can communicate with a host on a network through the communication unit 309 in conformity with a communication protocol such as the Ethernet (registered trademark). The drive 310 drives a removable media 311 which includes a magnetic disk, an optical disk, a magneto optical disk, or a semiconductor memory such as a USB memory.

The CPU 301 loads a program stored in the storage unit 308 to the RAM 303 through the input/output interface 305 and the bus 304 and executes the program, thereby performing the process as the key information management server.

The main process of the key information management server 300 using a computer is to manage the unique key information SEED allocated to each of the record reproduction apparatuses 200-1, 200-2, . . . . If the approval of a manager is received by performing a predetermined authentication process, the key information management server 300 can be accessed. In the case of manufacture or shipment, the manufacturer of the record reproduction apparatus 200 accesses the key information management server 300, obtains SEED, and writes SEED in the flash ROM 232. Further, the key information management server 300 can transmit the key information via a network connected using the communication unit 309 or through a removable media such as the USB memory mounted on the drive 310.

When the record reproduction apparatus 200 is out of order, the entire apparatus may be replaced or only the main substrate may be replaced. In this case, the external information recording medium 224, such as a USB HDD, remains in the hand of the user. After a repair operation, such as replacement, is finished, the external information recording medium 224 is connected to the record reproduction apparatus 200 again, and then used. The content, such as terrestrial digital broadcasting, is recorded in the external information recording medium 224, and it is apparent that the user has a proper right to watch the recorded content after the record reproduction apparatus 200 is repaired.

As described above, the content recorded in the external information recording medium 224 is encrypted using the encryption key generated based on SEED stored in the flash ROM 232. When a substrate is replaced, SEED, which was used when recording was performed, is lost due to the replacement. Therefore, it is difficult to reproduce the content, recorded in the external information recording medium 224 before a substrate is replaced, after the substrate is replaced, so that the user is inconvenienced.

Therefore, a mechanism for enabling content, which was recorded in the external information recording medium 224 before a substrate is replaced, to be reproduced even after the substrate is replaced will be described below. The fact that content, which was recorded in the external information recording medium 224, can be reproduced using a replaced substrate will be referred to as “takeover of external information recording medium” below.

In the side of the record reproduction apparatus 200, a currently attached substrate is associated with the external information recording medium 224 which is connected to the substrate using unique identification information by performing an operation called “registration”. Further, at the same time, a registration number is allocated such that the substrate of the record reproduction apparatus 200 can uniquely recognize the external information recording medium 224, and the registration number is written in the external information recording medium 224.

If the substrate of the record reproduction apparatus 200 is replaced, for example, a substrate A is replaced with a substrate B, the key information SEED varies. Therefore, it is difficult to reproduce the content, which were recorded in the external information recording medium 224 when the substrate A is attached, after the substrate A is replaced with the substrate B. In the present embodiment, a data structure, used to manage the identification information and key information SEED which are used for an operation of registering the external information recording medium 224, is determined, and the key information management server 300 is accessed through a predetermined authentication process, so that the identification information and the key information SEED, which are used for the register operation, of the substrate of the record reproduction apparatus 200 can be rewritten, thereby implementing the takeover of the external information recording medium. A network connected using the communication unit 309 and a removable media, such as a USB memory, which is attached to the drive 310, may be mentioned as an apparatus for accessing the key information management server 300.

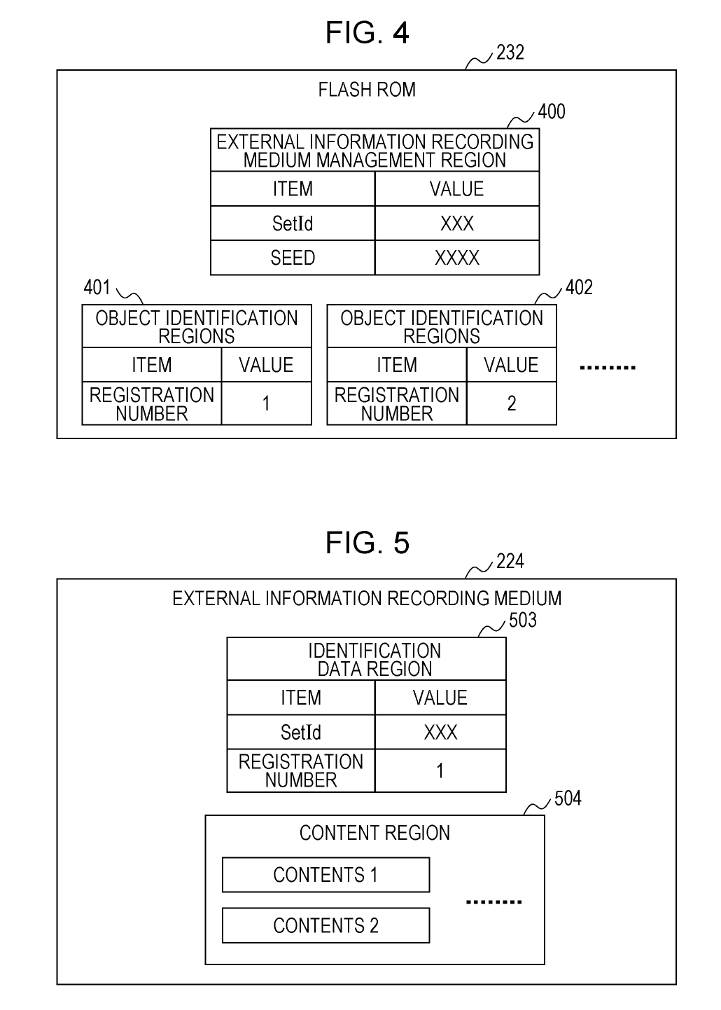

FIG. 4 illustrates data and data structure to be described in the flash ROM 232 of the record reproduction apparatus 200.

The identification information SetId and the key information SEED, which are unique to each substrate, are allocated to the record reproduction apparatus 200. The identification information SetId and the key information SEED are written in the external information recording medium management region 400 of the flash ROM 232, and are used to associate with the external information recording medium 224 which is connected for recording. As described below, SetId is written in the registered external information recording medium 224. The record reproduction apparatus 200 (the CPU 230 which instructs recording) can record broadcast content only in the external information recording medium 224 which has the same SetId as the record reproduction apparatus 200. Further, SEED is used to generate an encryption key (described above) when broadcast content is recorded in the external information recording medium 224 and the recorded content is reproduced. The use of the identification information SetId and the key information SEED in order to take over the external information recording medium will be described later.

A registration number capable of uniquely identifying an object is allocated to the external information recording medium 224 which is connected to the record reproduction apparatus 200. The external information recording medium management region 400 of the flash ROM 232 includes object identification regions 401, 402, . . . which each store a registration number used to recognize an object. The object identification regions 401, 402, . . . exist to the same number as the number of registered external information recording mediums 224.

Further, FIG. 5 illustrates the data and data structure to be described in the external information recording medium 224 which is connected to the record reproduction apparatus 200 and on which registration is performed. The data structure which is described in the external information recording medium 224 is divided into an identification data region 503 and a content region 504.

The identification data region 503 is a region where data indicating that the corresponding external information recording medium 224 is associated with the record reproduction apparatus 200 at the connection destination is written. In particular, the identification information SetId, which is unique to a current substrate, and a registration number, which is allocated to the corresponding external information recording medium 224 from the record reproduction apparatus 200, are written in the identification data region 503. The data of the identification data region 503 may be written in the user region of the external information recording medium 224 in the form of a file, and may be written in the designated address of a storage region in the form of raw data.

The content region 504 is a region where the encrypted recording content is written. Since the data structure of the content region 504 is not particularly relevant to the process of taking over the external information recording medium, the detailed description thereof is omitted in the present specification.

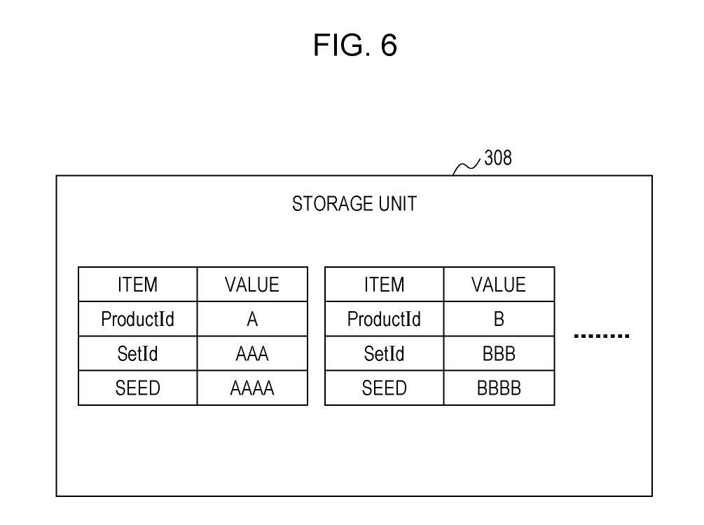

Further, FIG. 6 illustrates data and data structure to be described in the storage unit 308 of the key information management server 300. A unique identification information ProductId is allocated to the record reproduction apparatus 200. The unique identification information ProductId may be, for example, a product serial number. As information which is necessary to implement the takeover of the external information recording medium, the key information management server 300 writes the identification information SetId, which is used to identify a substrate which is currently attached to the record reproduction apparatus 200, and the key information SEED, which is allocated to the substrate, in the storage unit 308 in association with the identification information ProductId of the record reproduction apparatus 200, and manages the pieces of information. These pieces of information in the storage unit 308 can be accessed through a predetermined authentication process. A method of preparing the management information will be described later.

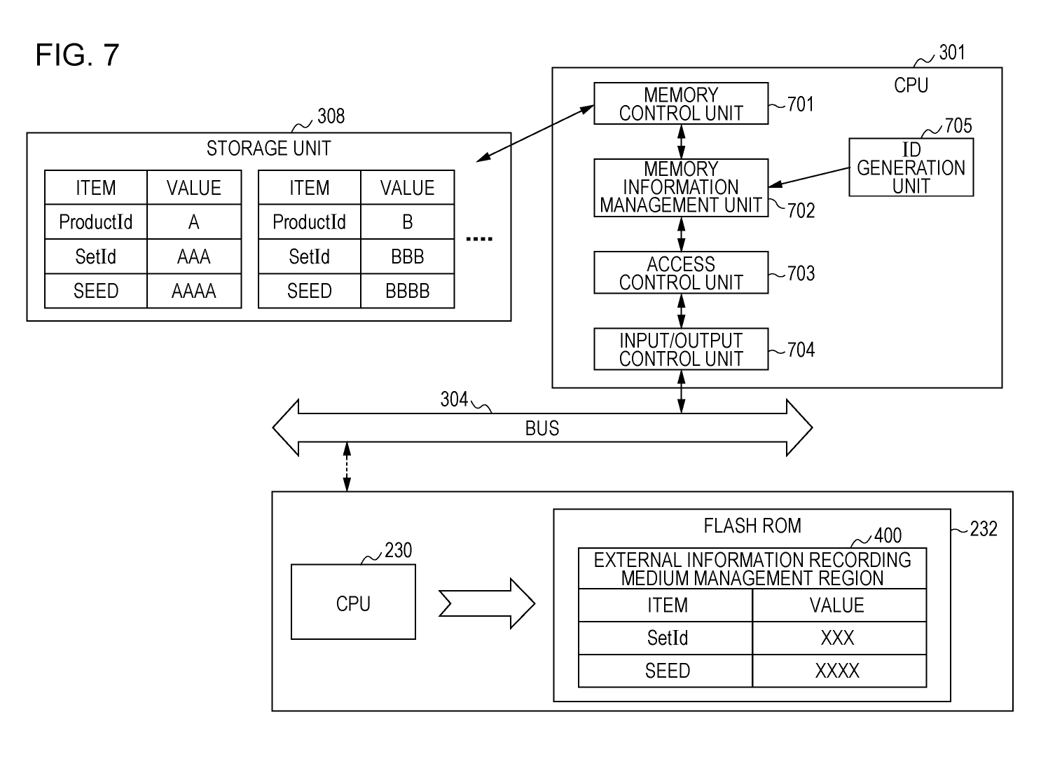

The data structure in the storage unit 308 of the key information management server 300 shown in FIG. 6 is configured when the record reproduction apparatus 200 is manufactured. FIG. 7 illustrates the configuration process.

A computer which operates as the key information management server 300 operates respective functional blocks, that is, a memory control unit 701, a memory information management unit 702, an access control unit 703, an input/output control unit 704, and an ID generation unit 705 by executing a predetermined key information management server application using the CPU 301.

The memory control unit 701 inputs and outputs data from and to the storage unit 308. The memory information management unit 702 manages information which is written in the storage unit 308. Although the access control unit 703 blocks the illegal access from the outside when taking over the external information recording medium, the access control unit 703 permits access to a data writing operation which is performed when the record reproduction apparatus 200 is manufactured. The access control unit 703 basically restricts access from an external network through the communication unit 309. The input/output control unit 704 exchanges data with the outside when the access control unit 703 permits access. The ID generation unit 705 prepares data (product identification information ProductId, substrate identification information SetId, and key information SEED) which is written in the storage unit 308 for each record reproduction apparatus 200.

All the record reproduction apparatuses 200 are connected to the key information management server 300 in the process of manufacturing a product, and each piece of data including the substrate identification information SetId and the key information SEED is written in the external information recording medium management region 400 of the flash ROM 232. As a method of connecting the record reproduction apparatus 200 to the key information management server 300, a USB cable attached to the drive 310 may be used as the medium or a network connected to the communication unit 309 may be used. The writing procedure will be described below.

First, the ID generation unit 705 prepares each data including the substrate identification information SetId and the key information SEED which will be written in the external information recording medium management region 400 of the flash ROM 232 of the record reproduction apparatus 200 and the storage unit 308.

Next, from the memory information management unit 702 through the memory control unit 701, each data including the substrate identification information SetId and the key information SEED prepared for the record reproduction apparatus 200 is written in the storage unit 308, in association with the product identification information ProductId of the record reproduction apparatus 200.

Further, from the memory information management unit 702 through the access control unit 703 and the input/output control unit 704, each data including the substrate identification information SetId and the key information SEED is written in the flash ROM 232 of the corresponding record reproduction apparatus 200. Meanwhile, in the case of manufacture, the object identification region (refer to FIG. 4) does not exist yet in the flash ROM 232. The object information regions 401, 402, . . . are prepared through the registration operation whenever a user who purchased the record reproduction apparatus 200 externally connects a new external information recording medium 224 to the USB interface 213.

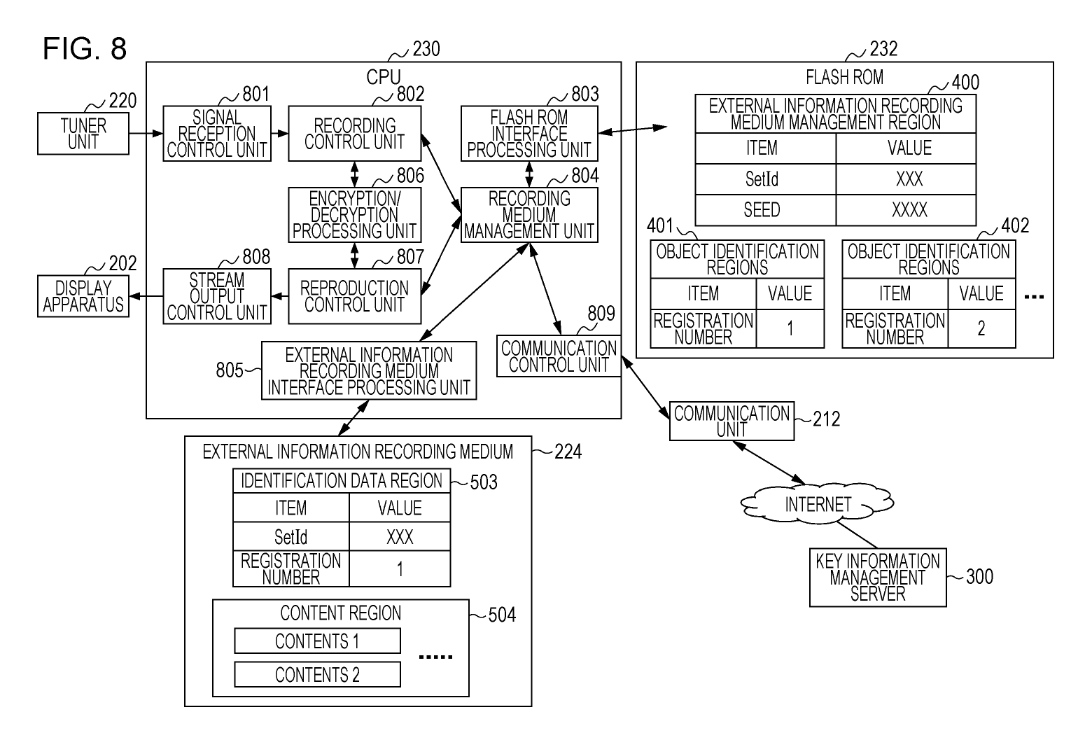

The data structure in the flash ROM 232 of the record reproduction apparatus 200 shown in FIG. 4 is configured through the registration operation whenever new external information recording medium 224 is externally connected to the USB interface 213. FIG. 8 illustrates the configuration process.

When the CPU 230 runs a predetermined program, each of the functional blocks, including a signal reception control unit 801, a recording control unit 802, a flash ROM interface processing unit 803, a recording medium management unit 804, an external information recording medium interface processing unit 805, an encryption/decryption processing unit 806, a reproduction control unit 807, a stream output control unit 808, and a communication control unit 809, operates.

The signal reception control unit 801 controls the process of a signal received using the tuner unit 220. The recording control unit 802 controls the recording of received content in the external information recording medium 224. The recording medium management unit 804 is a block for managing information recording, and manages information recording through the flash ROM interface control unit 803, the external information recording medium interface processing unit 805, such as the USB interface 213 which connects the external information recording medium 224, and the communication control unit 809.

The encryption/decryption processing unit 806 prepares an encryption key, which is used for the encryption and the decryption of content to be recorded, based on the key information SEED. The key information SEED is the unique value of an apparatus, which is allocated from the key information management server 300, and a unique encryption key of the apparatus is prepared. The reproduction control unit 807 controls the reproduction of the content which was recorded in the external information recording medium 224. The stream output control unit 808 outputs image streams to the display apparatus 202. The communication control unit 809 controls the access to the key information management server or the like through the communication unit 212.

The record reproduction apparatus 200 records content in the external information recording medium 224 which is connected through the USB interface 213. When content is recorded in the connected external information recording medium 224 or the recorded content is reproduced, it is necessary to associate the substrate of the record reproduction apparatus 200 with the external information recording medium 224 using the unique identification information by performing the registration operation.

When registration is performed, the recording medium management unit 804, first, reads the substrate identification information SetId from the external information recording medium management region 400 of the flash ROM 232 through the flash ROM interface processing unit 803, and copies the read substrate identification information SetId in the SetId item of the identification data region 503 of the external information recording medium 224 through the external information recording medium interface processing unit 805. Thereafter, the recording medium management unit 804 newly prepares the object identification regions 401, 402, . . . corresponding to the number of connected external information recording mediums 224 in the flash ROM 232, generates registration numbers corresponding to the respective connected external information recording mediums 224, and then writes the registration numbers in the corresponding object identification regions 401, 402, . . . . Further, the recording medium management unit 804 copies the value which is the same as the registration number in the registration number item of the identification data region 503 of the external information recording medium 224 through the external information recording medium interface processing unit 805. Here, the registration number enables each of the external information recording mediums 224 to be uniquely recognized. The registration number which can be uniquely recognized may be implemented using, for example, an algorithm that a value of 1 is allocated to the registration number when the object identification region does not exist, and a value obtained by adding 1 to the biggest value of existing registration numbers is determined to be the registration number when one or more object identification regions exist.

Further, when the external information recording medium 224 which is registered in the record reproduction apparatus 200 is once separated and then connected again, the external information recording medium 224 is recognized again as the registered external information recording medium 224. The new recognizing procedure will be described below.

The substrate identification information SetId of a record reproduction apparatus 200 at the connection destination and the registration number allocated by the external information recording medium 224 are written in the identification data region 503 of the external information recording medium 224 which was registered (or the data file of the identification data region 503 is stored in a user region). When the external information recording medium 224 is connected to the USB interface 213, the recording medium management unit 804 compares the value of SetId, which is read from the external information recording medium management region 400 of the flash ROM 232 interface processing unit 803, with the value of SetId, which is read from the identification data region 503 of the external information recording medium 224 through the external information recording medium interface processing unit 805. If the values of SetIds are not matched with each other, the external information recording medium 224 is not registered, so that it is difficult to recognize the external information recording medium 224. Meanwhile, when the values of SetIds are matched with each other, the recording medium management unit 804 additionally reads the registration number from the identification data region 503 of the external information recording medium 224 through the external information recording medium interface processing unit 805, and then searches all object number identification regions in the flash ROM 232 through the flash ROM interface processing unit 803 in order to determine whether a matching registration number exists. When the matching registration number exists, it is recognized that the external information recording medium 224 is registered. When the matching registration number does not exist, the external information recording medium 224 is not registered, so that it is difficult to recognize the external information recording medium 224.

Next, a process of recording content in the external information recording medium 224 using the record reproduction apparatus 200 will be described. As a precondition of the recording, the registered external information recording medium 224 is connected to the record reproduction apparatus 200.

When the recording starts, the recording control unit 802 reads the value of the key information SEED from the external information recording medium management region 400 of the flash ROM 232 through the recording medium management unit 804, and then transmits the value of the key information SEED to the encryption/decryption processing unit 806. The encryption/decryption processing unit 806 prepares the unique encryption key of an apparatus by applying predetermined arithmetic to the value of SEED, and then transmits the encryption key to the encryption unit 223.

The signal reception control unit 801 controls a broadcasting signal reception process in the tuner unit 220 and a decoding process in the MPEG decoder 221. Further, the encryption unit 223 encrypts decoded image data using the encryption key received from the encryption/decryption processing unit 806. Thereafter, the recording control unit 802 writes the encrypted content in the content region 504 of the external information recording medium 224 through the recording medium management unit 804 and the external information recording medium interface processing unit 805.

Next, a process of reproducing content, which was recorded in the external information recording medium 224, using the record reproduction apparatus 200 will be described. As precondition of the reproduction, the registered external information recording medium 224 is connected to the record reproduction apparatus 200 and the recorded content is written in the content region 504 of the external information recording medium 224.

When reproduction starts, the reproduction control unit 807 reads the value of the key information SEED from the external information recording medium management region 400 of the flash ROM 232 through the recording medium management unit 804 and the flash ROM interface processing unit 803, and then transmits the value of the key information SEED to the encryption/decryption processing unit 806. The encryption/decryption processing unit 806 prepares an encryption key by applying predetermined arithmetic to the value of SEED, and then transmits the encryption key to the encryption unit 223.

Thereafter, the reproduction control unit 807 reads the recorded content, which was written in the content region 504 of the external information recording medium 224, through the recording medium management unit 804 and the external information recording medium interface processing unit 805. The encryption unit 223 decrypts the recorded content using the encryption key received from the encryption/decryption processing unit 806, and then transmits the decrypted content to the stream output control unit 808. The stream output control unit 808 outputs image streams to the display apparatus 202.

Next, a process of taking over the external information recording medium such that content, which was recorded in the external information recording medium 224 before a substrate is replaced, can be reproduced after the substrate is replaced will be described. The process of taking over the recorded content can be performed using the key information management server 300.

The process of taking over the external information recording medium is broadly divided into two processes, that is, a process of rewriting substrate identification information SetId and key information SEED which were written in the external information recording medium management region 400 of the flash ROM 232 of a substrate which is replaced and a process of reconfiguring the object identification regions.

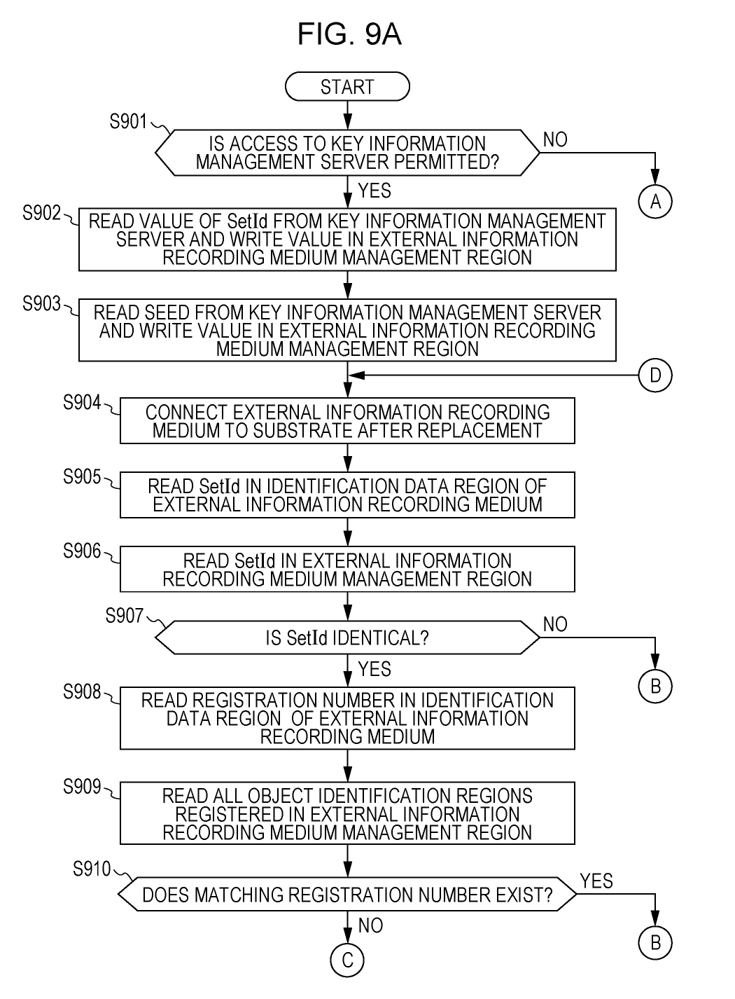

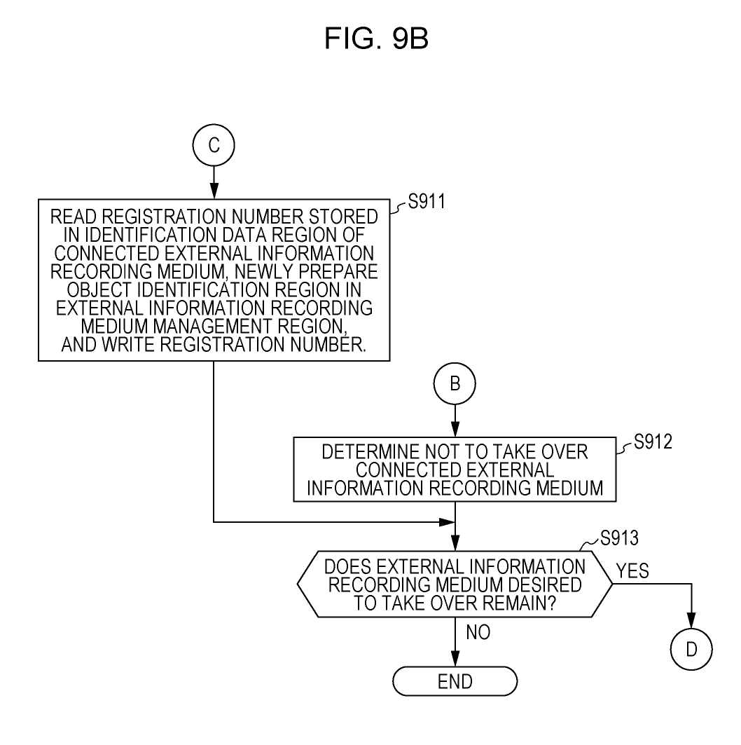

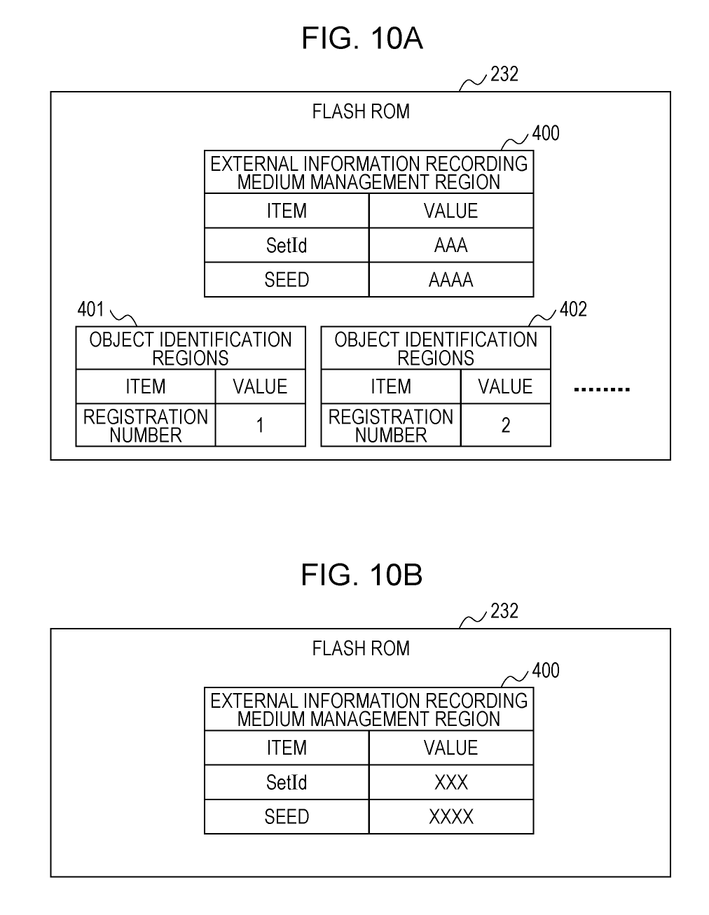

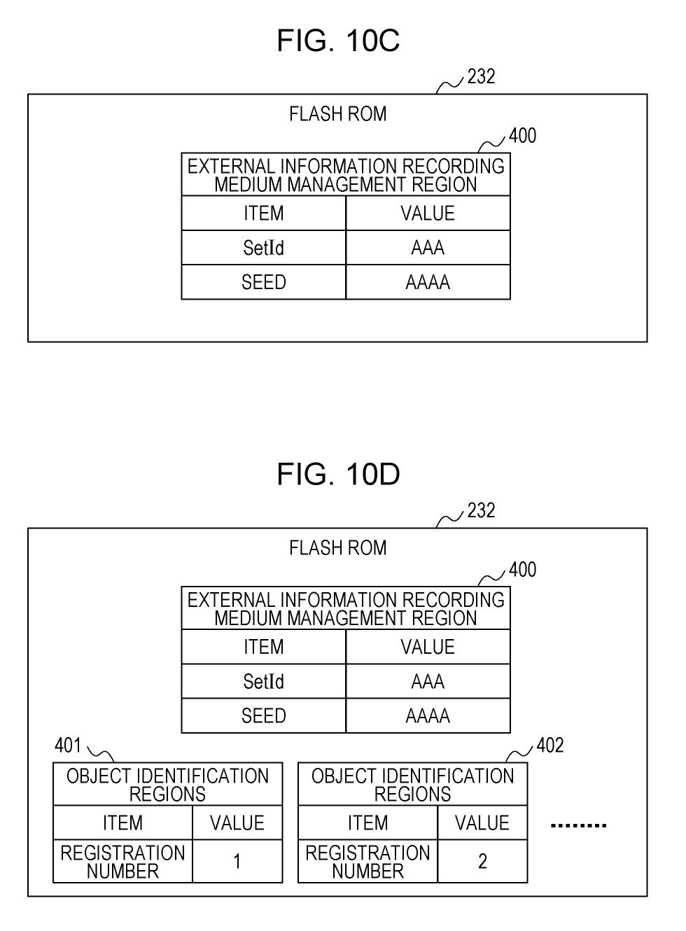

FIGS. 9A and 9B are flowcharts illustrating process procedure of taking over the external information recording medium 224. The process procedure can be implemented in such a way that, for example, the CPU 230 runs a predetermined program after a substrate is replaced. In the flowcharts of the drawings, the process is performed in such a way that the object identification region is reconfigured after the substrate identification information SetId and the key information SEED are rewritten. Further, FIGS. 10A to 10D illustrate that the external information recording medium management region 400 and the object identification regions 401, 402, . . . of the flash ROM 232 of a substrate after replacement are sequentially rewritten in the procedure of the takeover process. Hereinafter, the process procedure of taking over the external information recording medium of FIGS. 9A and 9B will be described by appropriately referring to FIG. 10A to 10D.

It is assumed that the process procedure shown in FIGS. 9A and 9B starts from a state in which the substrate of the record reproduction apparatus 200 has been already replaced. It is assumed that a substrate A corresponds to a substrate before replacement, and the substrate A is replaced with a substrate B.

FIG. 10A illustrates the state of the flash ROM 232 of the substrate A before replacement. As shown in the drawing, SetId “AAA” and key information SEED “AAAA” of the substrate A before replacement are written in the external information recording medium management region 400. The SetId “AAA” and the key information SEED “AAAA” of the substrate A are associated with the product identification information of the corresponding record reproduction apparatus 200 and are managed in the storage unit 308 of the key information management server 300. Further, in the substrate A before replacement, the object identification regions 401, 402, . . . , to which the registration numbers 1 and 2 are allocated, of the external information recording medium 224 are configured in the flash ROM 232.

Meanwhile, FIG. 10B illustrates the state of the flash ROM 232 of the substrate B after replacement. As shown in the drawing, SetId “XXX” and key information SEED “XXXX” of the substrate A before replacement are written in the external information recording medium management region 400. Further, the object identification region is not configured yet in the flash ROM 232 of the substrate B immediately after replacement.

Before the key information management server 300 is accessed, the access should be permitted. As a method of authenticating access, a method of issuing a password in advance may be mentioned.

When an operation of rewriting the substrate identification information SetId and the key information SEED, the recording medium management unit 804 accesses the key information management server 300 through the communication control unit 809. Thereafter, recording medium management unit 804 request that the substrate identification information SetId and the key information SEED, which were registered in the storage unit 308 of the key information management server 300, be obtained using the product identification information ProductId ProductId A of the record reproduction apparatus 200 whose substrate is replaced with the substrate B as a query (in step S901). Here, the product identification information ProductId corresponds to information recorded on the exterior of a product and is not written in the flash ROM 232. Meanwhile, when the authentication of the key information management server 300 fails (“No” in step S901), it is determined to be illegal access, and error-termination is performed on this process routine. Further, when the authentication of the key information management server 300 is successful (“Yes” in step S901), the process proceeds to subsequent step S902.

In step S902, the memory information management unit 702 of the key information management server 300 reads the substrate identification information SetId of the record reproduction apparatus 200 (substrate A), having the value of the requested product identification information ProductId, from the storage unit 308 through the memory control unit 701. The memory information management unit 702 outputs the read substrate identification information SetId through the input/output control unit 704. Thereafter, in the side of the record reproduction apparatus 200, the recording medium management unit 804 copies the value in the SetId item of the external information recording medium management region 400 of the flash ROM 232.

Subsequently, the memory information management unit 702 of the key information management server 300 reads the key information SEED of the record reproduction apparatus 200, having the value of the requested product identification information ProductId, from the storage unit 308 through the memory control unit 701. Thereafter, the memory information management unit 702 outputs the read key information SEED through the input/output control unit 704. Thereafter, in the side of the record reproduction apparatus 200, the recording medium management unit 804 copies the value in the SEED item of the external information recording medium management region 400 of the flash ROM 232 (in step S903).

FIG. 10C illustrates the state of the flash ROM 232 when the substrate identification information SetId and the key information SEED are rewritten in the substrate B after replacement. As shown in the drawing, the external information recording medium management region 400 is rewritten with the SetId “AAA” and the key information SEED “AAAA” of the substrate A before replacement. Further, the object identification region is not configured yet in the flash ROM 232 of the substrate B.

Subsequently, a single external information recording medium 224 desired to be taken over is connected to the USB interface 213 of the record reproduction apparatus 200 after the substrate is replaced with the substrate B (in step S904).

The recording medium management unit 804 reads the value of the substrate identification information SetId which is written in the identification data region 503 of the connected external information recording medium 224 through the external information recording medium interface processing unit 805 (in step S905).

Subsequently, the recording medium management unit 804 reads the value of the substrate identification information SetId, which is written in the external information recording medium management region 400 of the flash ROM 232, through the flash ROM interface processing unit 803 (in step S906).

Thereafter, the recording medium management unit 804 performs comparison in order to determine whether the pieces of substrate identification information SetIds which were read in steps 905 and 906, respectively, are matched with each other (in step S907). Here, if the values of the compared pieces of substrate identification information SetIds are matched (“Yes” in step S907), the process proceeds to step S908. Meanwhile, when both values of the pieces of substrate identification information SetIds are not matched (“No” in step S907), the process proceeds to step S912.

In step S908, the recording medium management unit 804 reads the value of the registration number, which is written in the identification data region 503, from one of the external information recording mediums 224, which are currently connected to the record reproduction apparatus 200, through the external information recording medium interface processing unit 805.

Subsequently, the recording medium management unit 804 reads all the values of registration numbers registered as the object identification regions of the external information recording medium management region 400 of the flash ROM 232 through the flash ROM interface processing unit 803 (in step S909).

As shown in FIG. 10C, an object identification region does not exist yet in the flash ROM 232 of the substrate B immediately after the substrate identification information SetId and the key information SEED are rewritten.

Subsequently, it is determined whether a value which is matched with the value of the registration number, read in step S908, is included in the values of the registration numbers, read in step S909 (in step S910). If the corresponding value is included (“Yes” in step S910), the process proceeds to step S912. If the corresponding value is not included, the process proceeds to next step S911.

In step S911, the recording medium management unit 804 newly prepares an object identification region in the external information recording medium management region 400 of the flash ROM 232, writes the value of the registration number read from the external information recording medium 224, and the process proceeds to step S913.

Meanwhile, in step S912, it is determined not to take over the external information recording medium 224, and the process proceeds to step S913.

In step S913, if an external information recording medium 224 desired to be taken over remains, the process returns to step S904, and the takeover process as described above is performed. Further, if an external information recording medium 224 desired to be taken over does not remain, the process routine is terminated.

FIG. 10D illustrates the state of the flash ROM 232 when the process routine is terminated. As shown in the drawing, the external information recording medium management region 400 is rewritten with the SetId “AAA” and the key information SEED “AAAA” of the substrate A before replacement. Further, the pieces of object identification information 401, 402, . . . related to each taken-over external information recording medium 224 reappear in the flash ROM 232. Therefore, content, recorded in the external information recording medium 224 using the substrate A before replacement, can be reproduced in the record reproduction apparatus 200 after the substrate is replaced with the substrate B.

In this specification, although description focused on the embodiments applied to record reproduction apparatuses connected to a Liquid Crystal Display (LCD) or a Plasma Display Panel (PDP) has been performed, the embodiments of the present disclosure can be applied to the case where the substrate of a television receiver which has a record reproduction function is replaced in the same manner. Further, the embodiments of the present disclosure can be applied to various types of apparatuses each of which records and reproduces data which is encrypted using an encryption key based on key information written in a substrate using an external information recording medium as well as apparatuses each of which records and reproduces content.

That is, the present disclosure has been disclosed using illustrative embodiments, and the description of the present specification should not be interpreted limitedly. In order to determine the gist of the present disclosure, the claims should be referred to.

The present disclosure contains subject matter related to that disclosed in Japanese Priority Patent Application JP 2011-019840 filed in the Japan Patent Office on Feb. 1, 2011, the entire contents of which are hereby incorporated by reference.

What is claimed is:

1. A key information management system comprising:
one or more record reproduction apparatuses each of which includes a substrate on which main components are mounted and which is replaceable from a main body of an apparatus, and a nonvolatile storage unit which is mounted on the substrate and which at least stores substrate identification information, used to identify the substrate, and key information of an encryption key; and
a key information management server which includes a storage unit for storing the substrate identification information and key information of the substrate, attached to each record reproduction apparatus, in association with product identification information of the record reproduction apparatus, and which permits an access to the storage unit through authentication,
wherein the record reproduction apparatus accesses the key information management server through the authentication after the substrate is replaced, and then rewrites substrate identification information and key information after the replacement, which are stored in the nonvolatile storage unit, with the substrate identification information and key information of the substrate before the replacement.

2. A record reproduction apparatus, comprising:
a substrate on which main components are mounted and which is replaceable from a main body of an apparatus;
a nonvolatile storage unit which is mounted on the substrate, and at least store substrate identification information, used to identify the substrate, and key information of an encryption key;
a connection unit which connects one or more external information recording mediums to the substrate;
a record reproduction unit which records content in the external information recording medium which is connected to the connection unit or which reproduces content from the external information recording medium;
an encryption unit configured to encrypt or decrypt content using the encryption key generated based on the key information stored in the nonvolatile storage unit when the record reproduction unit records or reproduces the content; and
a takeover processing unit which, when the substrate of the main body of the apparatus is replaced, rewrites substrate identification information and key information after replacement, which are stored in the nonvolatile storage unit of the replaced substrate, with the substrate identification information and the key information which were stored in the nonvolatile storage unit of the substrate before replacement, and which takes over the external information recording medium connected to the connection unit of the substrate before replacement using the substrate after replacement.

3. The record reproduction apparatus according to claim 2, further comprising a communication unit which connects to a network, and
wherein the takeover processing unit accesses a key information management server for storing the substrate identification information and the key information of the substrate attached to the record reproduction apparatus in association with product identification information of the record reproduction apparatus, obtains the substrate identification information and the key information of the substrate before replacement, and then rewrites the substrate identification information and the key information which are stored in the nonvolatile storage unit of the substrate after replacement.

4. The record reproduction apparatus according to claim 2, further comprising:
a registration unit which allocates a registration number to the external information recording medium connected to the connection unit, and registers the external information recording medium by writing an object identification region, in which the registration number is written, into the nonvolatile storage unit and writing an identification data region, in which the substrate identification information and the registration number are written, into the external information recording medium.

5. The record reproduction apparatus according to claim 4, further comprising:
a recognition unit which reads the substrate identification information and the registration number, which were written in the identification data region, from the external information recording medium connected to the connection unit, and, when the read substrate identification information is matched with the substrate identification information stored in the nonvolatile storage unit and when the object identification region which matches with the read registration number does not exist in the nonvolatile storage unit, recognizes the external information recording medium as the external information recording medium registered by the registration unit.

6. The record reproduction apparatus according to claim 5, wherein the record reproduction unit records content in the external information recording medium which was registered by the registration unit or which was recognized as being registered by the recognition unit.

7. The record reproduction apparatus according to claim 5, wherein the takeover processing unit reconfigures the object identification region by writing the object identification region, in which the registration number of the external information recording medium recognized by the recognition unit from among the external information recording mediums connected to the connection unit of the substrate after replacement is written, into the nonvolatile storage unit.

8. A key information management apparatus, comprising:
a storage unit which stores substrate identification information and key information of a substrate attached to each record reproduction apparatus in association with product identification information of each of the record reproduction apparatuses; and
an access control unit which accesses the storage unit through a predetermined authentication process.

9. The key information management apparatus according to claim 8, wherein the access control unit permits access to a data writing operation which is performed when each record reproduction apparatus is manufactured.

10. The key information management apparatus according to claim 8, further comprising:
an identification information generation unit which generates the substrate identification information and key information of the substrate attached to each of the record reproduction apparatuses.
